(19) United States
(12) Patent Application Publication
(10) Pub. No.: US 2017/0364103 A1
(43) Pub. Date: Dec. 21, 2017

(54) Shower Water Temperature Controller

(71) Applicant: Carlos H. Herrera, Des Plaines, IL (US)

(72) Inventor: Carlos H. Herrera, Des Plaines, IL (US)

(21) Appl. No.: 15/602,086

(22) Filed: May 22, 2017

Related U.S. Application Data
(60) Provisional application No. 62/339,794, filed on May 20, 2016.

(51) Int. Cl. G05D 23/13; E03C 1/04; F16K 31/04

(52) U.S. Cl. CPC G05D 23/134; E03C 1/0408; F16K 31/04; E03C 2001/0418

(57) ABSTRACT

A water temperature controller for a shower that comprises a quiet and efficient, thermostat controlled, motorized device that reliably monitors and maintains water temperature of a shower at a level set by a user for use in single valve or double valve shower systems.

### CLAIM OF PRIORITY

This patent application claims priority under 35 USC 119(e)(1) from U.S. Provisional Patent Application Ser. No. 62/339,794 filed May 20, 2016, of common inventorship herewith entitled, “Water Temperature Controller”,” which is incorporated herein by reference as though the same were set forth in its entirety

### FIELD OF THE INVENTION

The present invention pertains to the field of temperature regulators, and more specifically to the field of thermostat controlled temperature controllers, and even more specifically to the field of thermostat controlled water temperature controllers for use in showers.

### BACKGROUND OF THE INVENTION

The prior art has put forth several designs for thermostat controlled temperature controllers. Among these are:

U.S. Pat. No. 6,250,558 to Miguel E. Dogre Cuevas describes a shower temperature and pressure control system including a bathtub with an associated shower outlet. A mixing valve is coupled to a hot water source and a cold water source. The mixing valve controls the amount of hot water and cold water flowing out to maintain a total flow of water that has a constant temperature corresponding to a predetermined temperature. A restrictive valve controls the water pressure so that a flow of water is maintained with a constant pressure corresponding to a predetermined pressure. Finally, a control unit has temperature selection buttons adapted to transmit to the temperature sensor a predetermined temperature and pressure selection buttons adapted to transmit to the pressure sensor a predetermined pressure, thus affording a unique method of controlling both the temperature and pressure of a shower.

U.S. Pat. No. 5,944,255 to Manuchehr Shirmohamadi describes a self contained device that rapidly and accurately senses, controls and maintains the temperature of water delivered to the user of a shower or bath. A user presets a desired water temperature using a manual control interface. The invention uses a sensor located on or within the mixer outlet pipe to measure the temperature of the mixed water being delivered to the user. The sensor produces an input signal that is used by a microprocessor to calculate both derivative gain and proportional gain. A fuzzy logic also is used by the microprocessor to produce an output signal so the system responds quickly and accurately to quantum temperature changes and the rate of temperature change. The output signal controls a motor that, by means of action of gears, controls action of the water mixer valve, maintaining a constant temperature of water delivered to the user. A number of users can preset temperatures for their own comfort and are able to select their preset temperature before entering the shower, negating any need for manual trial and error adjustment. A lay person with no plumbing experience, and a minimum amount of mechanical ability, may retrofit the device to an existing water delivery system.

U.S. Pat. No. 4,854,498 to L. Dean Stayton describes a shower temperature control system that includes a single mixing valve connected between hot and cold sources of water and a shower head, a gear motor with a shaft connected to the mixing valve, a water temperature sensor positioned in the shower plumbing, a numeric keypad for numeric entry of desired shower water temperature, a potentiometer for alternate entry of desired shower temperature, and a controller which derives a motor drive signal from a difference between the sensed temperature and the set temperature. Initially when no temperature has been set, the controller maintains a safe default water temperature, such as ninety eight degrees Fahrenheit. The controller incorporates memory for the storage of a plurality of preset shower water temperatures which may be selected by selection keys on the keypad.

None of these prior art references describe the present invention.

While there are a few hardy Spartan type individuals who relish the prospect of leaving a warm bed on a chilly morning to step into a cold shower or a few masochists who enjoy a shower so hot it turns them red as lobsters, most people prefer to step into a warm and welcoming shower where water temperature suits a bather perfectly. Achieving such a temperature is a matter of trial and error, wastes a lot of water, and often involves a series of fine adjustments during the course of a shower.

The present invention, hereinafter referred to as The Water Temperature Controller, is a quiet and efficient, thermostat controlled, motorized device that reliably monitors and maintains water temperature of a shower at a level set by a user. The Water Temperature Controller functions to save water and provide an individual with a comfortable and enjoyable shower.

### SUMMARY OF THE INVENTION

It is an object of the present invention to provide a water temperature controller for a shower that comprises a quiet and efficient, thermostat controlled, motorized device that reliably monitors and maintains water temperature of a shower at a level set by a user.

It is a further object of the invention to provide a water temperature controller for a shower wherein the shower is equipped with a single valve having only one spigot.

It is a further object of the invention to provide a water temperature controller for a shower wherein the shower is equipped with a double valve having a hot water spigot and a cold water spigot.

### BRIEF DESCRIPTION OF THE DRAWINGS

FIG. 1 is a prototypical, slightly diagonal, front view of a thermostat component that is used with the present invention to set and monitor the water temperature desired by a user taking a shower.

FIG. 2 is a prototypical, illustrative view that shows a motorized servo mechanism which attaches to a shower's main supply pipe and includes a temperature sensor, a hot water in valve, a cold water in valve, a mixed water out pipe, a motor with drive gears, and a limit switch.

### DETAILED DESCRIPTION OF THE INVENTION

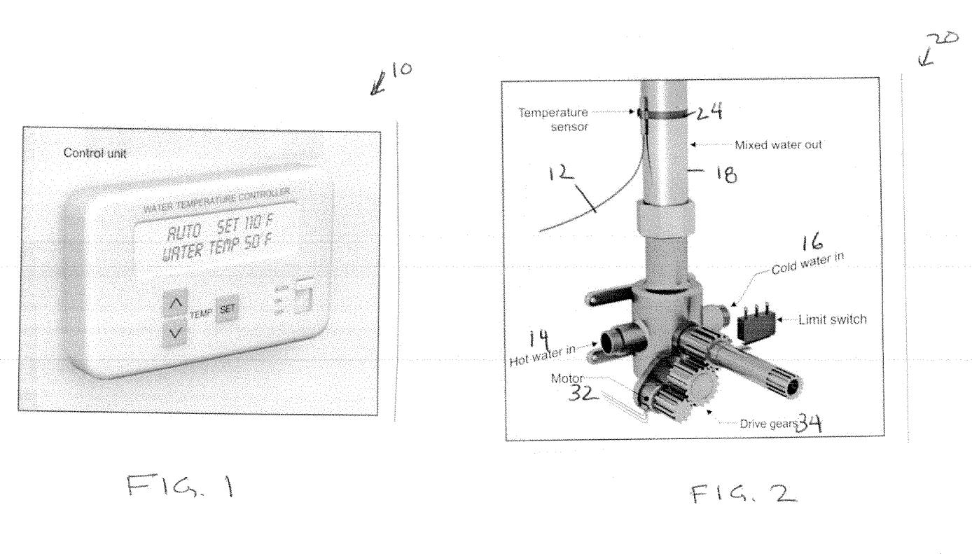

Please refer to the drawings. The Water Temperature Controller consists of two components. The first component is a thermostat 10, shown in FIG. 1 which detects the temperature of the water in a main supply pipe of a shower by means of a temperature sensing device, such as a thermocouple 12, shown in FIG. 2, and is set at a specific water temperature desires by a user. The second component is a motorized servo mechanism 20, shown in FIG. 2 which responds to the controlling thermostat 10 by adjusting hot water valve 14 and cold water valve 16 that feed hot and cold water into the main supply pipe 18. The thermostat 10 is a digital Light Emitting Diode or LED thermostat, and its corresponding temperature sensor 12 simply clamps to the exterior of the main supply pipe of a shower by any suitable means, such as by a strap 24.

Powered by a small Direct Current or DC motor 32, the servo mechanism adjusts single or dual valve shower controls by means of one or two contact friction wheels, or drive gears 34. As the temperature within the main supply pipe 18 changes, the thermostat 10 and servo mechanism 20 interact in a feedback loop to achieve and maintain the water temperature set on the thermostat. When the water temperature might normally decline toward the end of a long shower, the thermocouple measures the temperature and if senses a fall in temperature then acts to further open the hot water valve 14 or further limit the cold water valve 16, thereby automatically maintaining the desired water temperature.

The specific configuration of the servo mechanism 20 varies according to whether the shower to be equipped is a single valve or dual valve. The Water Temperature Controller is manufactured in two distinct models, one model for single valve and one model for dual valve. Installation of the present invention is relatively simple and straightforward.

The Water Temperature Controller eliminates trial and error guesswork involved in attempting to calibrate the temperature of one's shower water and eliminates discomfort experienced when one's water falls astray from one's desired temperature. With the Water Temperature Controller, a user simply sets a pushbutton digital thermostat to a desired water temperature, turns on a shower of water, waits a moment or two for the water to warm up, and then steps right into a perfectly comfortable and blissful temperature. Perfectly suited for household use, the Water Temperature Controller also functions effectively in hotels and other lodging establishments including gyms, schools, colleges and healthcare facilities.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A thermostat controlled, motorized water temperature controller for use in a shower, comprising:
a thermostat capable of detecting temperature of water in a main supply pipe of a shower by means of a temperature sensing device, such as a thermocouple and
wherein the thermostat is set at a specific water temperature desired by a user; and
a motorized servo mechanism which responds to the controlling thermostat by adjusting a hot water valve and a cold water valve that feed hot and cold water into a main supply pipe.

2. The water temperature controller of claim 1, wherein the thermostat is a digital Light Emitting Diode or LED thermostat, wherein the thermostat comprises a temperature sensor, wherein the temperature sensor clamps to the exterior of the main supply pipe of a shower.

3. The water temperature controller of claim 1 wherein the servo mechanism is powered by a Direct Current or DC motor, and the servo mechanism adjusts valve shower controls by means of contact friction wheels, or drive gears.

4. The water temperature controller of claim 3 wherein the shower is a single valve shower and the servo mechanism comprises one set of friction wheels or drive gears.

5. The water temperature controller of claim 3 wherein the shower is a double valve shower and the servo mechanism comprises two sets of friction wheels or drive gears.

6. The water temperature controller of claim 4, wherein the thermostat and servo mechanism interact in a feedback loop to achieve and maintain the water temperature set on the thermostat.

7. The water temperature controller of claim 5, wherein the thermostat and servo mechanism interact in a feedback loop to achieve and maintain the water temperature set on the thermostat.

8. The water temperature controller of claim 6, wherein the thermostat and servo mechanism interact in a feedback loop to achieve and maintain the water temperature set on the thermostat by opening the hot water valve.

9. The water temperature controller of claim 6, wherein the thermostat and servo mechanism interact in a feedback loop to achieve and maintain the water temperature set on the thermostat by closing the cold water valve.

10. The water temperature controller of claim 7, wherein the thermostat and servo mechanism interact in a feedback loop to achieve and maintain the water temperature set on the thermostat by opening the hot water valve.

11. The water temperature controller of claim 7, wherein the thermostat and servo mechanism interact in a feedback loop to achieve and maintain the water temperature set on the thermostat by closing the cold water valve.
